(19) United States
(12) Patent Application Publication
(10) Pub. No.: US 2012/0255008 A1
(43) Pub. Date: Oct. 4, 2012

(54) Method of Handling Malicious Application in Telco's Application Store System and Related Communication Device

(76) Inventors: Ju-Ting Yang, Taoyuan County (TW); Yin-Yeh Tseng, Taoyuan County (TW)

(21) Appl. No.: 13/433,291

(22) Filed: Mar. 29, 2012

Related U.S. Application Data
(60) Provisional application No. 61/468,587, filed on Mar. 29, 2011.

(30) Foreign Application Priority Data
Jan. 20, 2012 (TW) 101102604

(51) Int. Cl. G06F 21/00

(52) U.S. Cl. 726/23

(57) ABSTRACT

A method of handling a malicious application for a client of a service system is disclosed. The method comprises transmitting a malicious application report message to a storefront of the service system when detecting a malicious application, for reporting the malicious application to the storefront; and receiving a malicious application response message in response to the malicious application report message, wherein the malicious application response message is transmitted by the storefront.

### CROSS REFERENCE TO RELATED APPLICATIONS

this application claims the benefit of U.S. Provisional Application No. 61/468,587, filed on Mar. 29, 2011 and entitled “Malicious Application Report in Telco's Application Store”, the contents of which are incorporated herein in their entirety.

### BACKGROUND OF THE INVENTION

1. Field of the Invention

The present invention relates to a method used in a service system and related communication device, and more particularly, to a method of handling a malicious application in a Telco's Application Store (TAS) system and related communication device.

2. Description of the Prior Art

Open Mobile Alliance (OMA) is founded to develop OMA specifications for mobile services to meet users' needs. Furthermore, the OMA specifications aim to provide the mobile services which are interoperable across geographic areas (e.g. countries), operators, service providers, networks, operation systems and mobile devices. In detail, the mobile services conforming to the OMA specifications can be used by the users without restriction to particular operators and service providers. The mobile services conforming to the OMA specifications are also bearer agnostic, i.e., the bearer that carries the mobile services can be a second generation (2G) mobile system such as Global System for Mobile Communications (GSM), Enhanced Data rates for GSM Evolution (EDGE) or General Packet Radio Service (GPRS), or a third generation (3G) and beyond mobile system such as Universal Mobile Telecommunications System (UMTS), Long Term Evolution (LTE) or LTE-Advanced (LTE-A). Further, the mobile services can be executed on an operation system such as Windows, Android or Linux operated on various mobile devices. Therefore, industries providing devices or the mobile services supporting the OMA specifications can benefit from a largely growing market enabled by interoperability of the mobile services. Besides, the users use the devices or the mobile services supporting the OMA specifications can also have a better experience due to the interoperability of the mobile services.

Besides, the OMA develops a Telco's Application Store (TAS) specification for specifying sale, access, classification and development of applications (e.g., softwares), to promote the TAS specification to users and developers. In detail, a TAS system includes entities such as a TAS client, a storefront and a developer support. The TAS client can interact with the storefront, for example, browsing and downloading the applications provided by the storefront, and maintaining an installation status of a downloaded application. After the TAS client is installed in a device (e.g., a mobile device or a personal computer), the TAS client can deliver capability information of the device to the storefront by using existed transport protocols (e.g., HTTP User Agent Profile) when the TAS client requests to browse the applications, such that the storefront can provide the applications to the TAS client according to the capability information of the device. Please note that, an application must pass an audit process at the developer support, before the application is displayed by the storefront to the TAS client. The developer support manages the applications uploaded by the developers, and audits the uploaded applications and their related information.

However, the TAS specification does not specify how a TAS client reports a malicious application. When a user detects the malicious application, the user cannot report the malicious application to the storefront and the developer support, for handling the malicious application, e.g., authority can add the malicious application in a blacklist. Thus, the authority can punish malicious applications in the blacklist, e.g., denies the malicious applications in the blacklist (e.g., during a time period) being accessed by the user or being displayed at the storefront. Therefore, how to report a malicious application and what information should be included in a message reporting the malicious application are topics to be discussed.

### SUMMARY OF THE INVENTION

The present invention therefore provides a method and related communication device for handling a malicious application in a Telco's Application Store (TAS) system to solve the abovementioned problems.

A method of handling a malicious application for a client of a service system is disclosed. The method comprises transmitting a malicious application report message to a storefront of the service system when detecting a malicious application, for reporting the malicious application to the storefront; and receiving a malicious application response message in response to the malicious application report message, wherein the malicious application response message is transmitted by the storefront.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a Telco's Application Store system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

### DETAILED DESCRIPTION

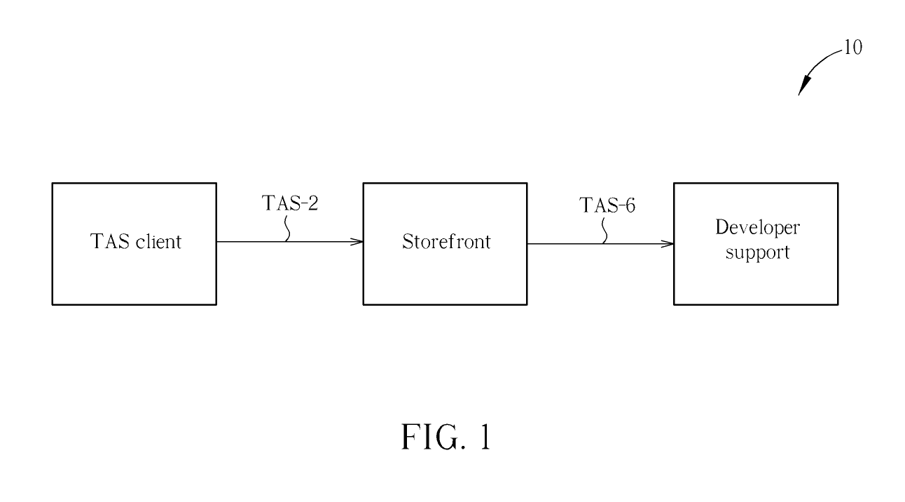

Please refer to FIG. 1, which is a schematic diagram of a Telco's Application Store (TAS) system 10 according to an example of the present invention. The TAS system 10 supports a TAS specification developed by Open Mobile Alliance (OMA), and is briefly composed of a TAS client, a storefront and a developer support. The TAS client can be installed in devices such as mobile phones, laptops, tablet computers, electronic books, portable computer systems and computer systems, for browsing and downloading applications provided by the storefront. Categories of the applications can include game, travel, product, entertainment, book, education, etc, wherein each of the applications can be free or not. In general, the storefront and the developer support are managed by a telecom operator or a service provider, and are installed in one or more servers, for providing the applications to the TAS client and managing the applications.

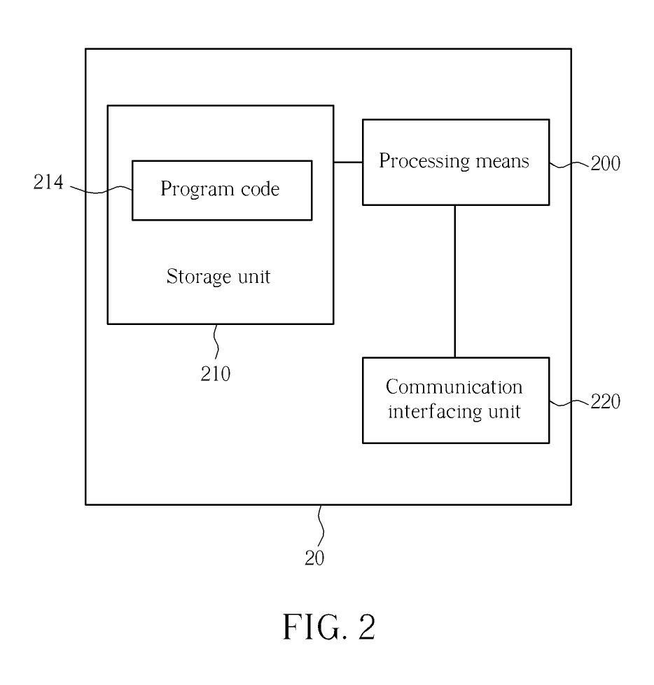

Please refer to FIG. 2, which is a schematic diagram of a communication device 20 according to an example of the present invention. The communication device 20 can be a device in which the TAS client is installed, or a server in which the storefront and/or the developer support is installed. The communication device 20 may include a processing means 200 such as a microprocessor or an Application Specific Integrated Circuit (ASIC), a storage unit 210 and a communication interfacing unit 220. The storage unit 210 may be any data storage device that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a transceiver, and can transmit/receive a message according to processing results of the processing means 200.

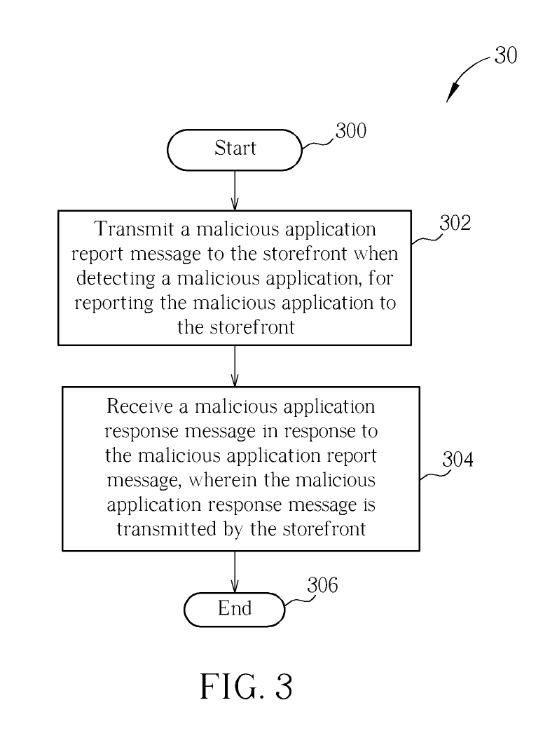

Please refer to FIG. 3, which is a flowchart of a process 30 according to an example of the present invention. The process 30 is utilized in the TAS client shown in FIG. 1, for handling a malicious application. The process 30 may be compiled into the program code 214 and includes the following steps:

Step 300: Start.

Step 302: Transmit a malicious application report message to a storefront of the TAS system 10 when detecting a malicious application, for reporting the malicious application to the storefront.

Step 304: Receive a malicious application response message in response to the malicious application report message, wherein the malicious application response message is transmitted by the storefront.

Step 306: End.

According to the step 302, when a user, who uses a device where the TAS client is installed and the process 30 is performed such as the communication device 20, detects (e.g., discovers) the malicious application, the TAS client can transmit the malicious application report message to the storefront, for reporting the malicious application to the storefront, wherein the malicious application report message includes information related to the malicious application. The information is provided to the storefront for further processing the malicious application. After processing the malicious application report message, the storefront transmits the malicious application response message to the TAS client, for replying a result of processing the malicious application, e.g., whether the malicious application report message is successfully received. Therefore, according to the step 304, the TAS client can receive the malicious application response message, to know the result of processing the malicious application. According to the process 30, the user can report the malicious application via the TAS client, to avoid that the malicious application is downloaded by other users, and inconvenience caused by the malicious application is reduced accordingly.

Please note that, a spirit of the present invention is that the TAS client transmits the malicious application report message to the storefront, for reporting the malicious application, and receives the malicious application response message transmitted by the storefront later, to know the result of processing the malicious application. Detail of the malicious application report message and the malicious application response message is not limited, as long as the abovementioned function can be realized. For example, the malicious application report message can include at least one of an identification of the TAS client, an identification of the malicious application, a comment and a reporting time. The identification of the TAS client is used for informing the storefront from whom the malicious application report message is sent. The identification of the malicious application client is used for explicitly (i.e., clearly) indicating the malicious application to the storefront. The comment can be used for informing the storefront a cause of reporting the malicious application, or can be used for providing a suggestion of how to process the malicious application to the storefront. The reporting time can be used for informing the storefront a time instant at which the TAS client transmits the malicious application report message, and the time instant can be treated as a reference of processing the malicious application. Preferably, the malicious application report message includes the identification of the TAS client, the identification of the malicious application, and the comment, such that the storefront has sufficient information for processing the malicious application. On the other hand, the malicious application response message may include a result, for indicating whether the storefront successfully receives the malicious application report message. Preferably, the TAS client and the storefront communicate with each other via a TAS-2 interface. That is, the TAS client transmits the malicious application report message to the storefront via the TAS-2 interface, and receives the malicious application response message transmitted by the storefront via the TAS-2 interface. Please note that, a one-way arrow representing the TAS-2 interface shown in FIG. 1 means that only after the TAS-2 interface is initiated (e.g., transmitting the malicious application report message) by the TAS client, the storefront can then respond (e.g., transmitting the malicious application response message) to the TAS client via the TAS-2 interface.

Therefore, according to the process 30 and the above-mentioned illustrations, a user can report a malicious application via the TAS client, to avoid that the malicious application is downloaded by other users, and inconvenience caused by the malicious application is reduced accordingly.

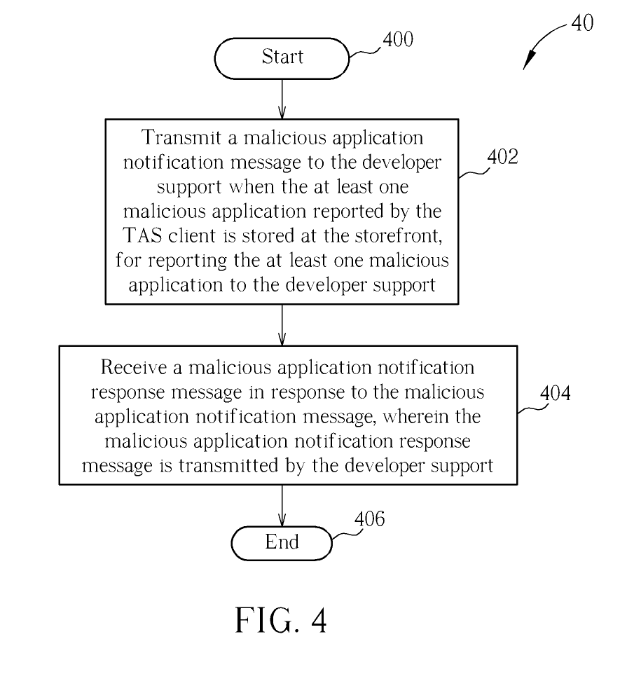

Please refer to FIG. 4, which is a flowchart of a process 40 according to an example of the present invention. The process 40 is utilized in the storefront shown in FIG. 1, for handling at least one malicious application. The process 40 may be compiled into the program code 214 and includes the following steps:

Step 400: Start.

Step 402: Transmit a malicious application notification message to the developer support when the at least one malicious application reported by the TAS client is stored at the storefront, for reporting the at least one malicious application to the developer support.

Step 404: Receive a malicious application notification response message in response to the malicious application notification message, wherein the malicious application notification response message is transmitted by the developer support.

Step 406: End.

According to the step 402, when the storefront stores (e.g., records) the at least one malicious application reported by the TAS client, the storefront transmits the malicious application notification message to the developer support, for reporting the at least one malicious application to the developer support, wherein the malicious application notification message includes information related to the at least one malicious application. The information is provided to the developer support for further processing the at least one malicious application. After processing the malicious application notification message, the developer support transmits the malicious application notification response message to the storefront, for replying a result of processing the at least one malicious application, e.g., whether the malicious application notification message is successfully received, or which developer of the at least one malicious application is added in a blacklist, for not being able to upload any application. Therefore, according to the step 404, the storefront can receive the malicious application notification response message, to know the result of processing the at least one malicious application. Please note that, if the TAS client reports the at least one malicious application to the storefront with a same comment included in the malicious application report message (e.g., according to the process 30), the storefront can report the at least one malicious application to the developer support at one time (e.g., in a single transmission). In general, before the storefront executes the process 40, the storefront may first confirm whether the at least one malicious application reported by the TAS client is reliable or valid (e.g., according to policy established by a telecom operator or a service provider). Therefore, according to the process 40, the storefront can report one or more malicious applications to the developer support, to avoid that a developer of a malicious application continues to upload one or more malicious applications, so as to reduce distribution of the malicious applications.

Please note that, a spirit of the present invention is that the storefront transmits the malicious application notification message to the developer support, for reporting the at least one malicious application, and receives the malicious application notification response message transmitted by the developer support later, to know the result of processing the at least one malicious application. Detail of the malicious application notification message and the malicious application notification response message is not limited, as long as the abovementioned function can be realized. For example, the malicious application notification message can include the number of the at least one malicious application, at least one identification of the at least one malicious application and a comment. The number of the at least one malicious application is used for informing the number of malicious applications included in the malicious application notification message. The at least one identification of the at least one malicious application is used for explicitly (i.e., clearly) indicating the at least one malicious application to the developer support. The comment can be used for informing the developer support a cause of reporting the at least one malicious application, or can be used for providing a suggestion of how to process the at least one malicious application to the developer support. In short, the malicious application notification message includes sufficient information of the at least one malicious application, such that the developer support can processes the at least one malicious application properly. On the other hand, the malicious application notification response message may include a result, for indicating whether the developer support successfully receives the malicious application notification message. Preferably, the storefront and the developer support communicate with each other via a TAS-6 interface. That is, the storefront transmits the malicious application notification message to the developer support via the TAS-6 interface, and receives the malicious application notification response message transmitted by the developer support via the TAS-6 interface. Please note that, a one-way arrow representing the TAS-6 interface shown in FIG. 1 means that only after the TAS-6 interface is initiated (e.g., transmitting the malicious application notification message) by the storefront, the developer support can then respond (e.g., transmitting the malicious application notification response message) to the storefront via the TAS-6 interface.

Therefore, according to the process 40 and the above-mentioned illustrations, the storefront can report one or more malicious applications to the developer support using a single message, “malicious application notification message” (by only one transmission) sharing the same comment, to avoid that a developer of a malicious application continues to upload one or more malicious applications, so as to reduce distribution of the malicious applications.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a method of handling a malicious application. Thus, a user can report the malicious application, to avoid that the malicious application is downloaded by other users. Besides, the storefront can report one or more malicious applications to the developer support, to avoid that a developer of a malicious application continues to upload one or more malicious applications, so as to reduce distribution of the malicious applications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling a malicious application, for a client of a service system, the method comprising:
transmitting a malicious application report message to a storefront of the service system when detecting a malicious application, for reporting the malicious application to the storefront; and
receiving a malicious application response message in response to the malicious application report message, wherein the malicious application response message is transmitted by the storefront.

2. The method of claim 1, wherein the malicious application report message comprises at least one of an identification of the client, an identification of the malicious application, a comment and a reporting time.

3. The method of claim 2, wherein the malicious application report message comprises the identification of the client, the identification of the malicious application, and the comment.

4. The method of claim 3, wherein the comment comprises a cause or a suggestion for transmitting the malicious application report message.

5. The method of claim 1, wherein the malicious application response message comprises a result.

6. The method of claim 5, wherein the result comprises information of whether the storefront successfully receives the malicious application report message.

7. The method of claim 1, wherein the service system is a Telco's Application Store (TAS) system developed by Open Mobile Alliance (OMA).

8. The method of claim 7, wherein the client transmits the malicious application report message to the storefront via a TAS-2 interface, and receives the malicious application response message transmitted by the storefront via the TAS-2 interface.

9. A method of handling at least one malicious application, for a storefront of a service system, the service system comprising a client, the storefront and a developer support, the method comprising:
transmitting a malicious application notification message to the developer support when the at least one malicious application reported by the client is stored at the storefront, for reporting the at least one malicious application to the developer support; and
receiving a malicious application notification response message in response to the malicious application notification message, wherein the malicious application notification response message is transmitted by the developer support.

10. The method of claim 9, wherein the malicious application notification message comprises the number of the at least one malicious application, at least one identification of the at least one malicious application and a comment.

11. The method of claim 10, wherein the comment comprises a cause or a suggestion for transmitting the malicious application notification message.

12. The method of claim 9, wherein the malicious application notification response message comprises a result.

13. The method of claim 12, wherein the result comprises information of whether the developer support successfully receives the malicious application notification message.

14. The method of claim 9, wherein the service system is a Telco's Application Store (TAS) system developed by Open Mobile Alliance (OMA).

15. The method of claim 14, wherein the storefront transmits the malicious application notification message to the developer support via a TAS-6 interface, and receives the malicious application notification response message transmitted by the developer support via the TAS-6 interface.
